(19) United States
(12) Patent Application Publication
(10) Pub. No.: US 2010/0225576 A1
(43) Pub. Date: Sep. 9, 2010

(54) THREE-DIMENSIONAL INTERACTIVE SYSTEM AND METHOD

(75) Inventors: Tomer Yosef Morad, Tel Aviv (IL); Hayim Weller, Rechovot (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: HORIZON SEMICONDUCTORS LTD., Herzliya (IL)

(21) Appl. No.: 12/396,565

(22) Filed: Mar. 3, 2009

(51) Int. Cl. G09G 5/00; G06T 15/00

(52) U.S. Cl. 345/156; 345/419

(57) ABSTRACT

The present invention relates to a method for providing an intuitive interactive control object in stereoscope comprising the steps of: (a) providing a display capable of displaying in stereoscope; (b) providing a system capable of motion tracking; (c) tracking a visual signal motion performed by a user; (d) providing a stereoscopic image of a remote control, on said display in response to said signal performed by said user; (e) tracking user's motion aimed at interacting with said displayed stereoscopic image of said remote control; (f) analyzing said user's interactive motion; and (g) performing in accordance with said user's interactive motion.

### FIELD OF THE INVENTION

The present invention relates to the field of 3-Dimensional displays. More particularly, the invention relates to a system and method for providing an image of a 3-D control object to a user and allowing the user to control the system by gestures aimed at the image of the 3-D control object.

### BACKGROUND OF THE INVENTION

Stereoscopic systems have developed enormously in recent years due to advances in processing power, and advances in 3-D display methods. As of today not only movies and pictures may be displayed in stereoscope but also games and multimedia contents are provided for stereoscopic displays.

Stereoscopic displays can be produced through a variety of different methods, some of the common methods include:

Anaglyph—in an anaglyph, the two images are either superimposed in an additive light setting through two filters, one red and one cyan. In a subtractive light setting, the two images are printed in the same complementary colors on white paper. Glasses with colored filters in either eye separate the appropriate images by canceling the filter color out and rendering the complementary color black.

ColorCode 3-D—designed as an alternative to the usual red and cyan filter system of anaglyph. ColorCode uses the complementary colors of yellow and dark blue on-screen, and the colors of the glasses' lenses are amber and dark blue.

Eclipse method—with the eclipse method, a mechanical shutter blocks light from each appropriate eye when the converse eye's image is projected on the screen. The projector alternates between left and right images, and opens and closes the shutters in the glasses or viewer in synchronization with the images on the screen.

A variation on the eclipse method is used in LCD shutter glasses. Glasses containing liquid crystal will let light through in synchronization with the images on the display, using the concept of alternate-frame sequencing.

Linear polarization—in order to present a stereoscopic motion picture, two images are projected superimposed onto the same screen through orthogonal polarizing filters. A metallic screen surface is required to preserve the polarization. The viewer wears low-cost eyeglasses which also contain a pair of orthogonal polarizing filters. As each filter only passes light which is similarly polarized and blocks the orthogonally polarized light, each eye only sees one of the images, and the effect is achieved. Linearly polarized glasses require the viewer to keep his head level, as tilting of the viewing filters will cause the images of the left and right channels to blend. This is generally not a problem as viewers learn very quickly not to tilt their heads.

Circular polarization—two images are projected superimposed onto the same screen through circular polarizing filters of opposite handedness. The viewer wears low-cost eyeglasses which contain a pair of analyzing filters (circular polarizers mounted in reverse) of opposite handedness. Light that is left-circularly polarized is extinguished by the right-handed analyzer; while right-circularly polarized light is extinguished by the left-handed analyzer. The result is similar to that of stereoscopic viewing using linearly polarized glasses; except the viewer can tilt his head and still maintain left to right separation.

RealD and masterimage—are electronically driven circular polarizers that alternate between left and right-handedness, and do so in sync with the left or right image being displayed by the digital cinema projector.

Dolby 3-D—In this technique, the red, green and blue primary colors used to construct the image in the digital cinema projector are each split into two slightly different shades. One set of primaries is then used to construct the left eye image, and one for the right. Very advanced wavelength filters are used in the glasses to ensure that each eye only sees the appropriate image. As each eye sees a full set of red, green and blue primary colors, the 3-D image is recreated authentically with full and accurate colors using a regular white cinema screen.

Autostereoscopy is a method of displaying 3-D images that can be viewed without the use of special headgear or glasses on the part of the user. These methods produce depth perception in the viewer even though the image is produced by a flat device.

Several technologies exist for autostereoscopic 3-D displays. Currently most of such flat-panel solutions are using lenticular lenses or parallax barrier. If the viewer positions their head in certain viewing positions, they will perceive a different image with each eye, giving a stereo image.

Lenticular or barrier screens—in this method, glasses are not necessary to view the stereoscopic image. Both images are projected onto a high-gain, corrugated screen which reflects light at acute angles. In order to see the stereoscopic image, the viewer must sit perpendicular to the screen. These displays can have multiple viewing zones allowing multiple users to view the image at the same time.

Other displays use eye tracking systems to automatically adjust the two displayed images to follow the viewer's eyes as he moves his head.

WO 2008/132724 discloses a method and apparatus for an interactive human computer interface using a self-contained single housing autostereoscopic display configured to render 3-D virtual objects into fixed viewing zones. The disclosed system contains an eye location tracking system for continuously determining both a viewer perceived 3-D space in relation to the zones and a 3-D mapping of the rendered virtual objects in the perceived space in accordance with a viewer eyes position. One or more 3-D cameras determine anatomy location and configuration of the viewer in real time in relation to said display. An interactive application that defines interactive rules and displayed content to the viewer is also disclosed. The disclosed interaction processing engine receives information from the eye location tracking system, the anatomy location and configuration system, and the interactive application to determine interaction data of the viewer anatomy with the rendered virtual objects from the autostereoscopic display. Nevertheless the disclosed tracking system requires a sophisticated tracking system for tracking the viewer's eyes in relation to the zones.

It is an object of the present invention to provide a method for displaying a stereoscopic image of a 3-D interactive object.

It is another object of the present invention to provide a method for intuitively controlling a display system.

It is still another object of the present invention to integrate stereoscopic display methods and movement tracking systems for providing a comfortable and intuitive control system and method.

Other objects and advantages of the invention will become apparent as the description proceeds.

### SUMMARY OF THE INVENTION

The present invention relates to a method for providing an intuitive interactive control object in stereoscope comprising the steps of: (a) providing a display capable of displaying in stereoscope; (b) providing a system capable of motion tracking; (c) tracking a visual signal motion performed by a user; (d) providing a stereoscopic image of a remote control, on said display in response to said signal performed by said user; (e) tracking user's motion aimed at interacting with said displayed stereoscopic image of said remote control; (f) analyzing said user's interactive motion; and (g) performing in accordance with said user's interactive motion.

Preferably, the method further comprises the step of adjusting the displayed stereoscopic image of the remote control in accordance with the user's interactive motion.

In one embodiment the stereoscopic image of the remote control is super imposed over a stereoscopic movie.

In another embodiment, the stereoscopic image of the remote control is super imposed over a 2-D movie.

The present invention also relates to a system for providing an intuitive stereoscopic interactive control object comprising: (a) a display capable of displaying stereoscopic images; (b) a camera capable of capturing motion on a video stream; and (c) a control box capable of receiving and analyzing said motion on said video stream from said camera and capable of displaying a stereoscopic image of a remote control on said display and capable of controlling said system based on said motion.

### BRIEF DESCRIPTION OF THE DRAWINGS

In the drawings:

FIG. 1 is a schematic diagram of a 3-Dimensional interactive control system according to one embodiment of the invention.

### DETAILED DESCRIPTION OF PREFERRED EMBODIMENTS

The following description of the method of the invention may use any method or system for stereoscopic displaying, such as the Anaglyph method, the Eclipse method, the barrier screens method, or any other known 3-D display method. The following description also makes use of video motion tracking which is the process of locating a moving object in time using a camera. An algorithm analyzes the video frames and outputs the location and motion of moving targets within the video frames. The video tracking systems typically employ a motion model which describes how the image of the target might change for different possible motions of the object to track. For the purpose of the invention any known video tracking method may be used such as: Blob tracking, Kernel-based tracking (Mean-shift tracking), Contour tracking, etc.

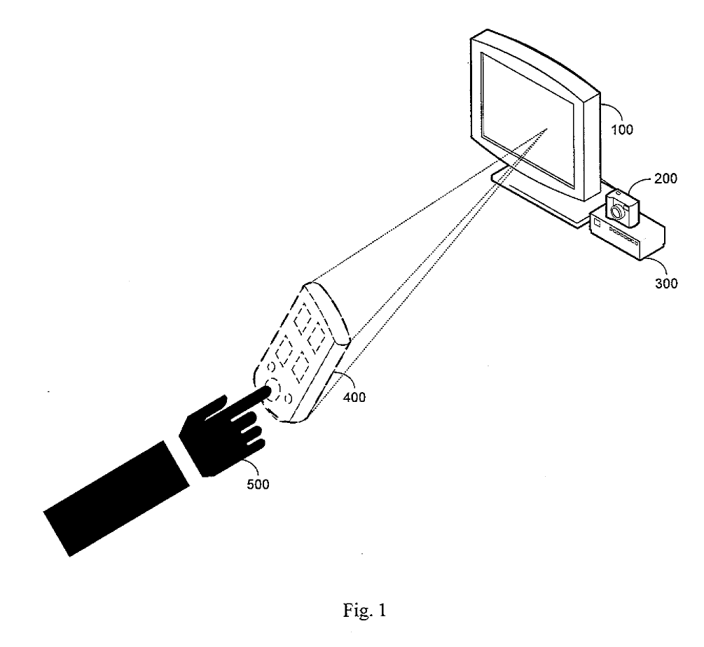

FIG. 1 is a schematic diagram of a 3-Dimensional interactive control system according to one embodiment of the invention. In this embodiment the user may be watching a movie or any other media contents on screen 100. Camera 200 which may be a simple web camera, a 3-D camera, or a number of cameras located at different angles to capture in 3-D the motion of the user. When the user is watching the movie on screen 100 he may wish to control the system, e.g. to turn the volume up. At this point the user can signal to the system to display a remote control in one of many ways such as: waving, raising a hand, clapping, or any other preset gesture or signal. The control box 300, which is capable of analyzing motion from a video stream, i.e. video motion tracking, receives the video stream from camera 200 and identifies the gesture. The control box 300 may be a Set-top box (STB), a computer, or any other processing element capable of processing incoming video data from camera 200 and capable of producing a media stream for displaying stereoscopic objects. After identifying the gesture and its approximated location, control box 300 displays an image of a remote control 400 (in silhouette) in stereoscope on screen 100 in the approximated location of the users hand or any other preset location. Once the user sees the image of the remote control 400 in stereoscopy he can try to manipulate the image by pressing, with his hand 500, a button, or turning a knob of the displayed remote control 400 or any other motion aimed at controlling the system. At this point the attempted manipulation, i.e. the hand motion, is filmed by camera 200 and sent to control box 300 which analyzes the incoming video stream, tracks the motion, and proceeds accordingly. If the user tries to turn the knob of the volume, on remote control 400, the control box 300 can change the volume of the movie accordingly and change the image display of the volume knob of remote control 400 accordingly, as if it has been turned. Thus the user may receive the experience as if he is turning a knob of a real remote control. The displayed remote control 400 may be super imposed over the displayed movie. Thus the user may continue watching the movie while using the remote control without the need to lower his eyes from the screen and look for the remote control.

In one of the embodiments, control box 300, as described in relation to FIG. 1, is integrated in screen 100. In another embodiment the camera 200 is integrated in control box 300. In yet another embodiment camera 200 and control box 300 are integrated together in screen 100, or any other combination thereof.

In one of the embodiments, the stereoscopic interactive remote control image is super imposed over a stereoscopic video. In another embodiment the stereoscopic interactive remote control image is super imposed over a 2-D video. In yet another embodiment, the stereoscopic interactive remote control image is displayed alone without being super imposed over a video. The stereoscopic interactive remote control image may be super imposed over a video, a single picture, or any other multimedia or graphical display.

In one of the embodiments, the displayed remote control may be preset by the user to include certain buttons, in a certain language, for controlling certain functions of the system, having a certain skin, etc.

In one of the embodiments the system is capable of displaying more than one image of a remote control. For example, two users watching together media contents may each wish to control different aspects of the contents.

In one of the embodiments, the stereoscopic view is a view of an internet browser where the user may control the browser using gestures of his hands aimed at the browser or aimed at a stereoscopic displayed control.

In one of the embodiments, the system may display stereoscopic images of a plurality of 3-D objects, such as pictures, music albums, video cassettes, etc., where the user can point or signal with his hands to which object he wishes to control.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims.

1. A method for providing an intuitive interactive control object in stereoscope comprising the steps of:
a. providing a display capable of displaying in stereoscope;
b. providing a system capable of motion tracking;
c. tracking a visual signal motion performed by a user;
d. providing a stereoscopic image of a remote control, on said display in response to said signal performed by said user;
e. tracking user's motion aimed at interacting with said displayed stereoscopic image of said remote control;
f. analyzing said user's interactive motion; and
g. performing in accordance with said user's interactive motion.

2. A method according to claim 1, further comprising the step of adjusting the displayed stereoscopic image of the remote control in accordance with the user's interactive motion.

3. A method according to claim 1, where the stereoscopic image of the remote control is super imposed over a stereoscopic movie.

4. A method according to claim 1, where the stereoscopic image of the remote control is super imposed over a 2-D movie.

5. A system for providing an intuitive stereoscopic interactive control object comprising:
a. a display capable of displaying stereoscopic images;
b. a camera capable of capturing motion on a video stream; and
c. a control box capable of receiving and analyzing said motion on said video stream from said camera and capable of displaying a stereoscopic image of a remote control on said display and capable of controlling said system based on said motion.
